(19) United States
(12) Patent Application Publication
(10) Pub. No.: US 2015/0013010 A1
(43) Pub. Date: Jan. 8, 2015

(54) SYSTEM AND METHOD FOR WORK MONITORING

(71) Applicant: Giora ROZENSWEIG, Kfar Saba (IL)

(72) Inventor: Giora Rozenzweig, Kfar Saba (IL)

(21) Appl. No.: 14/365,627

(22) PCT Filed: Nov. 12, 2012
(86) PCT No.: PCT/IB2012/002299

§ 371 Date: Jun. 14, 2014

Related U.S. Application Data
(60) Provisional application No. 61/570,829, filed on Dec. 15, 2011.

(51) Int. Cl. H04L 29/08; G06Q 10/06; H04L 29/06

(52) U.S. Cl. CPC H04L 67/22; H04L 63/145; G06Q 10/063
USPC 726/24; 709/224

(57) ABSTRACT

The invention provides methods to track a constellation of computer user actions. The method inter alia logs the amount of active time using a given application, using a set of measures including measurement of keyboard and mouse activity. Thus for example a threshold may be set such that an application is considered to be in active use until a pause of a given minimum duration (such as two minutes) in both keyboard and mouse activity is detected. Individual keystrokes and mouse actions may be recorded as well, allowing one to reconstruct the entirety of a user's online activity exactly. All remote connections, communications, websites visited, chats, and the like may be easily logged and/or monitored in real time by means of the invention.

### CROSS REFERENCE TO RELATED APPLICATIONS

This application claims priority from U.S. Provisional Application No. 61/570,829, filed 15 Dec. 2011 which is hereby incorporated by reference in its entirety.

### BACKGROUND

1. Technical Field

Embodiments of the present invention relate generally to systems and methods for monitoring activities taking place on computers.

2. Description of Related Art

Modern office productivity can suffer due to a number of factors including the increasing use of online means for personal activity, such as social networking, chatting, personal emails, trip planning, shopping, watching videos, listening to the radio, reading material not relevant to work, and the like. As the amount of tempting material on the net grows, so does productivity suffer for those workers in an online environment.

Various methods exits for monitoring online activity, however these generally involve relatively primitive methods such as counting keystrokes, logging websites, and other very specific means and methods. Hence, an improved method for monitoring computer activity is still a long felt need.

### BRIEF SUMMARY

An aspect of the present invention provides a method for monitoring user activity on a set of computers comprising steps of:
a. installing monitoring software on said computers, said software adapted to gather information concerning processes of said computers;
b. installing reporting software on a supervisory computer;
c. sending said information from said monitoring software to said supervisory computer;
wherein said monitoring software gathers information on all aspects of said user activity.

It is farther within provision of the invention wherein said computers, are networked to a server.

It is further within provision of the invention comprising monitoring software 105 running on said server 102 adapted to monitor access to databases 104 and the internet 103.

It is further within provision of the invention wherein remote workstations 107 are additionally monitored by means of said software 106.

It is further within provision of the invention wherein said monitoring software 106 is adapted to gather information selected from the group consisting of: mouse events, keyboard events, running application data, background application data, communications data; removable media status; file transfer data.

It is further within provision of the invention wherein said reporting software is adapted to display information selected from the group consisting of; realtime user activity; and summary user activity data.

It is further within provision of the invention wherein said realtime user activity is selected from the group consisting of: keyboard events; mouse events; running application data, background application data, and communications data.

It is further within provision of the invention wherein said summary user activity data is selected from the group consisting of: logs of active time using all applications; logs of active time using files; logs of time elapsed using each file.

It is further within provision of the invention wherein said reporting software is adapted to provide information about said users selected from the group consisting of: hours worked; hours idle; web sites visited; amount of time spent working on company affairs: amount of time worked on non-company affairs.

It is further within provision of the invention wherein said reporting software is further adapted to detect events selected from the group consisting of: virus installation; virus activity; hacking activity; Trojan horse installation.

It is further within provision of the invention wherein said software is adapted to prevent access to data selected from the group consisting of: a predetermined set of files; a predetermined set of web addresses.

It is within provision of the invention to disclose a system for monitoring user activity on a set of computers comprising;
a. monitoring software running on said computers adapted to gather information concerning processes of said computers;
b. reporting software running on a supervisory computer 108;
wherein said information is sent from said monitoring software 106 to said supervisory computer.

It is further within provision of the invention wherein said computers are networked to a server.

It is further within provision of the invention further comprising monitoring software running on said server adapted to monitor access to databases and the internet.

It is further within provision of the invention wherein remote workstations are additionally monitored by means of said software.

It is further within provision of the invention wherein said monitoring software is adapted to gather information selected from the group consisting of: mouse events, keyboard events, running application data, background application data, communications data; removable media status; file transfer data.

It is further within provision of the invention, wherein said reporting software is adapted to display information selected from the group consisting of: realtime user activity; and summary user activity data.

It is further within provision of the invention wherein said realtime user activity is selected from the group consisting of: keyboard events; mouse events; running application data, background application data, and communications data.

It is further within provision of the invention wherein said summary user activity data is selected from the group consisting of: logs of active time using all applications; logs of active time using files; logs of time elapsed using each file.

It is further within provision of the invention wherein said reporting software is adapted to provide information about said users selected from the group consisting of: hours worked; hours idle; web sites visited; amount of time spent working on company affairs; amount of time worked on non-company affairs.

It is further within provision of the invention wherein said reporting software is further adapted to detect events selected from the group consisting of: virus installation; virus activity; hacking activity; Trojan horse installation.

It is further within provision of the invention wherein said software is adapted to prevent access to data selected from the group consisting of: a predetermined set of files; a predetermined set of web addresses.

These, additional, and/or other aspects and/or advantages of the present invention are: set forth in the detailed description which follows: possibly inferable from the detailed description; and/or learnable by practice of the present invention.

### BRIEF DESCRIPTION OF THE DRAWINGS

In order to understand the invention and to see how it may be implemented in practice, a plurality of embodiments will now be described, by way of non-limiting example only, with reference to the accompanying drawings, in which:

FIG. 1 illustrates a system diagram consistent with the provisions of the invention with software running on the server;

FIG. 2 illustrates a system diagram consistent with the provisions of the invention with no software running on the server;

FIG. 3 illustrates a system diagram consistent with the provisions of the invention with software running on the server and a remote workstation;

FIG. 4 illustrates a system diagram consistent with the provisions of the invention with no software running on the server and a remote workstation.

### DETAILED DESCRIPTION

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a means and method for providing a system and method for monitoring activity of a computer user.

In the following detailed description, numerous specific details are set forth in order to provide a thorough understanding of embodiments of the present invention. However, those skilled in the art will understand that such embodiments may be practiced without these specific details. Reference throughout this specification to “one embodiment” or “an embodiment” means that a particular feature, structure, or characteristic described in connection with the embodiment is included in at least one embodiment of the invention.

The term ‘plurality’ refers hereinafter to any positive integer (e.g, 1, 5, or 10).

The term ‘mobile device’ refers hereinafter to any device having communication and computation means, including cellphones, mobile phones, smartphones, PDAs, laptops, tablet computers, and the like.

The term ‘remote connection’ refers hereinafter to any method for connecting to a computer using networked means, including VPN, terminals, cloud methods, and the like. By means of remote connections, for instance, workers can work from home while accessing remote/office files, databases, services, applications, and the like.

The modern office worker with his cubicle and internet connection is a lamb in a wonderland of ever more tempting online delights which sap his time, energy, and other resources. More generally speaking, office productivity suffers due to any number of factors including increasing use of online means for personal activity, such as social networking, chatting, personal emails, trip planning, shopping, watching videos, listening to the radio, reading material not relevant to work, facebook frolicking, myspace mucking about, twitter tweeting, pornographic perambulations, computer games, side projects, gossiping, reading the news, and the like. As the amount of tempting material on the net grows, so does productivity suffer for those workers in an online environment.

The invention provides means and methods to track computer user actions. The method logs the amount of active time using a given application using a set of measures including measurement of keyboard and mouse activity. Thus for example a threshold may be set such that an application is considered to be in active use until a pause of a given minimum duration (such as two minutes) in both keyboard and mouse activity is detected. It is within provision of the invention that individual keystrokes and mouse actions be recorded as well, allowing one to reconstruct the entirety of a user's online activity exactly.

The invention monitors all network activity at a basic level, allowing the system to identify a wide range of actions, communications, applications and the like. The invention monitors all computer activity for a given business, including employee office computers, computers at various office branches, laptops, servers, and out-of-office activity such as remote connection through VPN or the like, and moreover can also be implemented upon various mobile devices such as smartphones, tablets and the like.

The amount of active time using each application is logged and transmitted to a supervisory application, which may be used to monitor in real time the activity of every computer running the inventive application, and/or to peruse activity summaries including for example the total amount of time each day, week or other time period using a given application.

By this means, one can for example bill clients according to total hours worked for them. The total number of hours invested in a given project, for a given client, or in a given folder may be tracked and used. The total amount of resources (cpu time, number of nodes, number of workers, etc.) used for a given client or a given project may likewise be tracked.

It is further within provision of the invention to monitor which files are open by which application. This will be found useful for example for project management, billing, planning, and the like, as a worker and/or supervisor can look hack over a work week (for instance) and determine how much time was spent on which projects.

It is within provision of the invention to track the activities of a given computer user or set of computer users in real time, this information being compiled and logged such that concise histories may be provided.

A further provision of the invention allows for the tracking of all incoming and outgoing information and application use. By this means, many insidious operations can be detected. For instance, the sending of confidential information, installation and/or operation of viruses and trojan horses, and the like will all be detected and reported by the system. Hacking, sabotage, and espionage both from within an organization and from without are visible using the system.

Furthermore, hackers' entry into a given computer system will be tracked just as the actions of a legitimate user would be, allowing system administrators to detect and foil such operations.

The precise hours of activity for a given user are tracked by the system, allowing for example a supervisor to easily track when a given employee starts and stops his work day, including breaks during the day, and including remote employees who telecommute. Thus total hours worked can be computed for purposes of performance review and the like.

It is within provision of the invention that the system operator may not only observe the activities of a given system, but also control such remotely, for example opening/closing/executing/killing applications, programs, sites, viruses, and the like.

It is within provision of the invention to log the addresses of all connections from a given computer, allowing one to monitor for instance which web sites have been visited from a given computer.

It is within provision of the invention to monitor and log all internet and intranet activity of every employee of a business, including browser activity, messaging activity (ie. chat, forums, etc) and any other application using network connectivity.

It is within provision of the invention that the system may be implemented without requiring any installation on user computers.

The activity monitoring may be configured to monitor only active applications, such that only actual productive time is measured. Thus for example applications running in the background and/or programs that are open but not currently being used, are considered inactive.

The inventive system is able to furthermore log such information as the locations from which a given worker connects—be it a company computer, an external device, a terminal, VPN, or the like.

It is within provision of the invention to monitor and log the exploits of each user, including sites visited, applications and/or programs being am and/or utilized (actively), document(s) open and document(s) being used, the amount of time elapsed in each of the aforementioned activities, which actions have been taken such as ‘cut’, ‘copy’, ‘paste’, ‘insert’ and the like, and any other action that a user can perform on a given machine.

It is within provision of the invention to alert the system administrator upon detection of an unauthorized user gaining entry to a system, accessing unauthorized files, or the like, according to a profile of alert conditions.

It is within provision of the invention to monitor all attempts to distribute internal company information, including email transmissions, attachment of portable media such as usb drives, disks, cd's and the like.

It is within provision of the device to prevent access to given files, by means of a set of permissions that may be defined specifically for each user.

It is within provision of the invention to record installation of applications on a given computer, including personal applications, unregistered software, spyware, file sharing applications, viruses, Trojan horses, and the like.

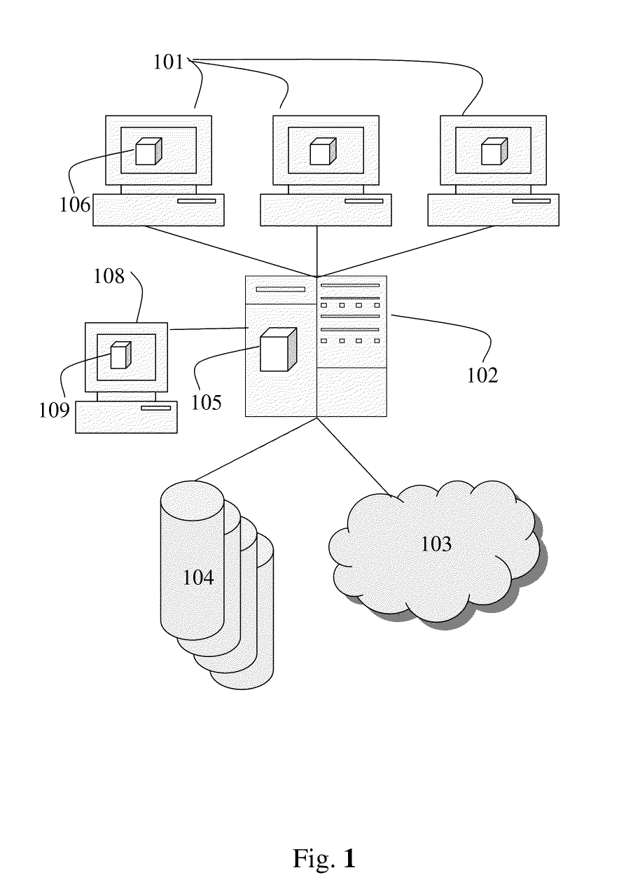

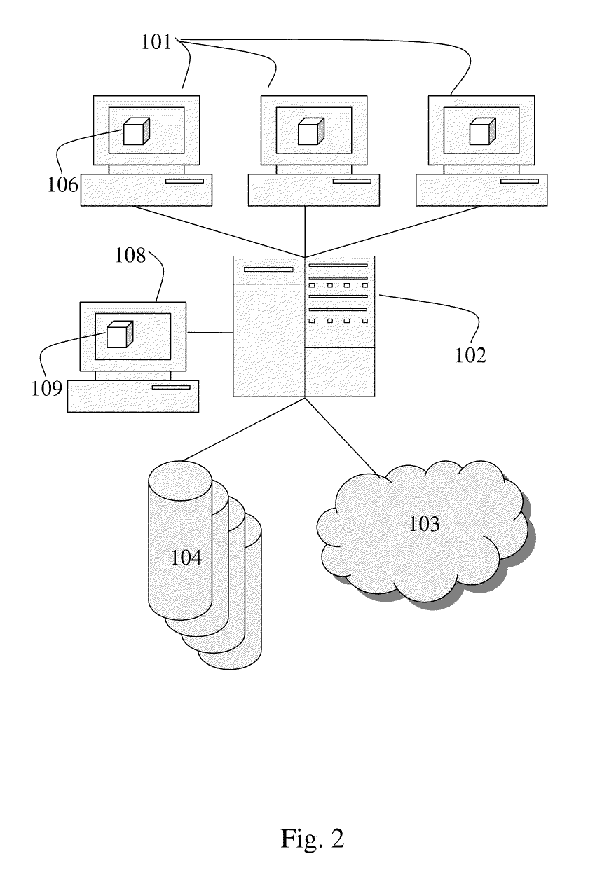

In FIG. 1 a system diagram is shown of one possible implementation of the system. Office workstations 101 are connected to a server 102. This server is in turn connected to company databases 104 and acts as a gateway (possibly through one or more intermediate steps such as firewalls, gateways and the like) to the internet, Since all communications to the databases 104 and internet 103 ultimately pass through the server 102, software of the invention 105 running on the server 102 can monitor this traffic in realtime. Further software may be implemented on the workstations 101 to monitor keyboard and mouse activity as well as possibly other activity such as running programs, communications, system status and the like. Alternatively, software of the invention may be run on the workstations 101 alone, with no software running on the server; this is an option shown in FIG. 2. In this case the software 106 running on workstations 101 records both mouse events, keystrokes, web access, databases access, and possibly other data.

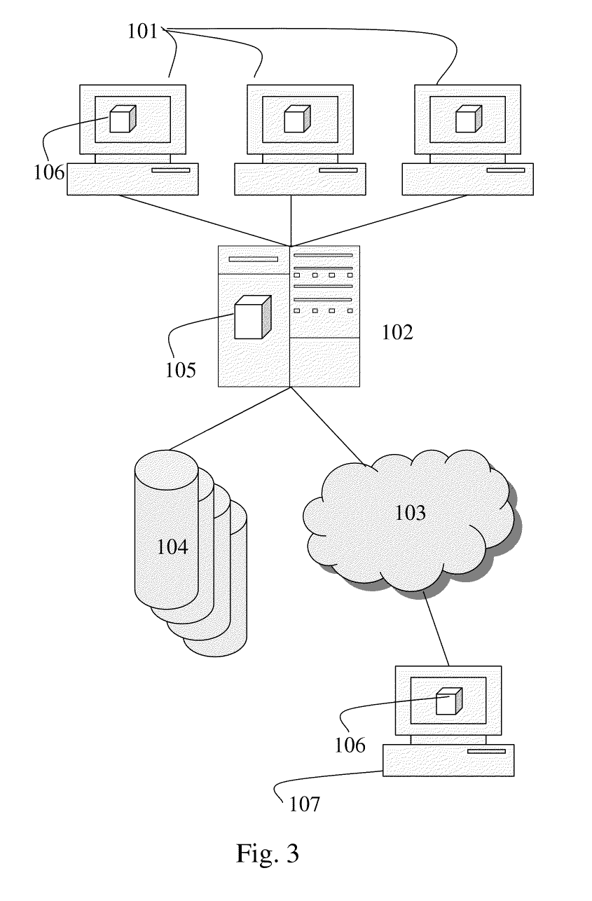

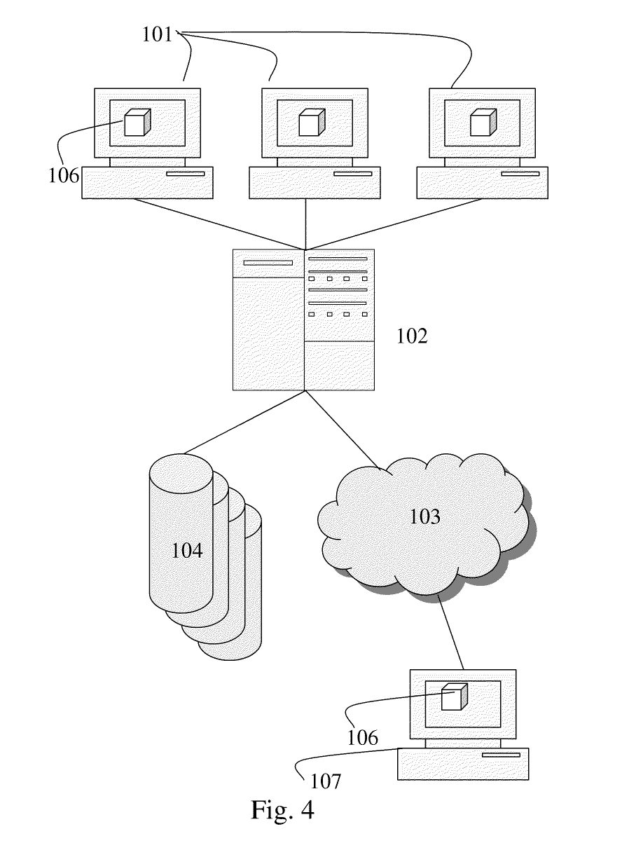

In FIG. 3 a system diagram is shown of another possible implementation of the system. Office workstations 101 are connected to a server 102. This server is in turn connected to company databases 104 and acts as a gateway (possibly through one or more intermediate steps such as firewalls, gateways and the like) to the internet. The telecommuting employee uses a computer 107 that connects to the server 102 over the internet 103 for instance by means of a VPN connection. Since all communications to the databases 104 and internet 103 ultimately pass through the server 102, software of the invention 105 running on the server 102 can monitor this traffic in realtime. Further software may be implemented on the workstations 101,106 to monitor keyboard and mouse activity as well as possibly other activity such as running programs, communications, system status and the like. Alternatively, software of the invention may be run on the workstations 101 alone, with no software running on the server; this is an option shown in FIG. 4. In this case the software 106 running on workstations 101,107 records both mouse events, keystrokes, web access, databases access, and possibly other data.

Although selected embodiments of the present invention have been shown and described, it is to be understood the present invention is not limited to the described embodiments. Instead, it is to be appreciated that changes may be made to these embodiments without departing from the principles and spirit of the invention, the scope of which is defined by the claims and the equivalents thereof.

1. A method for monitoring user activity on a set of computers 101 comprising steps of:
installing monitoring software 106 on said computers, said software adapted to gather information concerning processes of said computers;
installing reporting software 109 on a supervisory computer 108;
sending said information from said monitoring software 106 to said supervisory computer 108;
wherein said monitoring software gathers information on ail aspects of said user activity.

2. The method of claim 1 wherein said computers 106, 108 are networked to a server 102.

3. The method of claim 2 further comprising monitoring software 105 running on said server 102 adapted to monitor access to databases 104 and the internet 103.

4. The method of claim I wherein remote workstations 107 are additionally monitored by means of said software 106.

5. The method of claim 1 wherein said monitoring software 106 is adapted to gather information selected from the group consisting of: mouse events, keyboard events, running application data, background application data, communications data; removable media status: file transfer data.

6. The method of claim 1 wherein said reporting software is adapted to display information selected from the group consisting of; realtime user activity; and summary user activity data.

7. The method of claim 6 wherein said realtime user activity is selected from the group consisting of: keyboard events; mouse events; running application data, background application data, and communications data.

8. The method of claim 6 wherein said summary user activity data is selected from the group consisting of: logs of active time using all applications; logs of active time using files; logs of time elapsed using each file.

9. The method of claim 1 wherein said reporting software is adapted to provide information about said users selected from the group consisting of: hours worked; hours idle; web sites visited; amount of time spent working on company affairs; amount of time worked on non-company affairs.

10. The method of claim 1 wherein said reporting software 109 is further adapted to detect events selected from the group consisting of; virus installation; virus activity; hacking activity; Trojan horse installation.

11. The method of claim 1 wherein said software 106 is adapted to prevent access to data selected from the group consisting of: a predetermined set of files; a predetermined set of web addresses.

12. A system for monitoring user activity on a set of computers 101 comprising:
monitoring software 106 running on said computers adapted to gather information concerning processes of said computers;
reporting software 109 running on a supervisory computer 108;
wherein said information is sent from said monitoring software 106 to said supervisory computer 108.

13. The system of claim 12 wherein said computers 106, 108 are networked to a server 102.

14. The method of claim 13 further comprising monitoring software 105 running on said server 102 adapted to monitor access to databases 104 and the internet 103.

15. The system of claim 12 wherein remote workstations 107 are additionally monitored by means of said software 106.

16. The system of claim 12 wherein said monitoring software 106 is adapted to gather information selected from the group consisting of: mouse events, keyboard events, running application data, background application data, communications data; removable media status; file transfer data.

17. The system of claim 12 wherein said reporting software is adapted to display information selected from the group consisting of: realtime user activity; and summary user activity data.

18. The system of claim 17 wherein said realtime user activity is selected from the group consisting of; keyboard events; mouse events; running application data, background application data, and communications data.

19. The system of claim 17 wherein said summary user activity data is selected from the group consisting of: logs of active time using all applications: logs of active time using files; logs of time elapsed using each file.

20. The system of claim 12 wherein said reporting software is adapted to provide information about said users selected from the group consisting of: hours worked; hours idle; web sites visited; amount of time spent working on company affairs; amount of time worked on non-company affairs.

21. The system of claim 12 wherein said reporting software 109 is further adapted to detect events selected from the group consisting of: virus installation; virus activity; hacking activity; Trojan horse installation.

22. The system of claim 12 wherein said software 106 is adapted to prevent access to data selected from the group consisting of; a predetermined set of files; a predetermined set of web addresses.
